(19) United States
(12) Patent Application Publication
(10) Pub. No.: US 2013/0198072 A1
(43) Pub. Date: Aug. 1, 2013

(54) PORTABLE SYSTEM PERFORMING BUSINESS CENTER OPERATIONS

(71) Applicants: Nischal M. Piratla, Hyderabad (IN); Mark Pettit, Warwickshire (GB); Kovendhan Ponnavaikko, Chennai (IN); Meera Sampath, Rochester, NY (US); Herald Saldanha, Mumbai (IN); Tarun Goswami, New Delhi (IN)

(72) Inventors: Nischal M. Piratla, Hyderabad (IN); Mark Pettit, Warwickshire (GB); Kovendhan Ponnavaikko, Chennai (IN); Meera Sampath, Rochester, NY (US); Herald Saldanha, Mumbai (IN); Tarun Goswami, New Delhi (IN)

(21) Appl. No.: 13/359,510

(22) Filed: Jan. 27, 2012

(51) Int. Cl. G06Q 40/02; G06F 3/12

(52) U.S. Cl. 705/43; 705/42; 358/1.15

(57) ABSTRACT

The present disclosure discloses a portable business operations system having a multi-function device, a network interface and a user interface. Broadly, the multi-function device parses the content of one or more filled in application forms and verifies the completeness or accuracy of the forms. The network interface provides connectivity and communication between the portable system and one or more remotely located systems. Moreover, the user interface sends or receives electronic documents to and from one or more remotely located systems.

### TECHNICAL FIELD

The presently disclosed embodiments relate to various types of services/operations and more particularly, to a portable system performing business center operations.

### BACKGROUND

Banking, telecom, postal related services play a significant role in the day-to-day life of an individual. To use any of these services, customer needs to interact with the associated branches or centers. With the advent of the Internet, most of the activities can be performed online. For instance, bank customers can perform routine transactions, such as transferring funds, applying for loans, and viewing account summary, through online banking In remote or rural areas, however, persons may not be widely aware of online services, and thus those services tend to be underused. Even if the people in the rural areas know how to use the online services, network connectivity is the issue in those areas. In general, customers must visit a nearby bank branch or the telecom center for certain specific services. For example, an individual must visit a nearby branch and complete an application form for opening a new account, applying for loans, changing contact information, or similar services. This process often requiring, submitting one or more documents such as address proof, identity proof and so forth. The completed applications forms and the other related documents are sent to back office or processing center via courier. Then, one or more employees of the processing center perform a manual check in a line job manner, for each field of the submitted documents. If all the information is in order, then an employee scans the documents, and manually updates the information into the bank system; thereby, enhancing redundancy. Subsequently, a bank employee or a third party verifies the submitted information. In particular, the third party visits the residence of the customer to verify the identity of the customer and the submitted documents. Those processes require a significant manual effort, and thus, unnecessarily increases the processing time. Moreover, the processing time can run into weeks or months, particularly, for remote locations. In case the information in the documents is incomplete or not in order, then the documents are couriered back to branch office and the whole process is repeated.

Branch office hours are often limited, and queues are often long. No matter how small the task, a visit to the branch is required. Hard copies, completed in triplicate, are the norm. Moreover, branches are often unprofitable for the parent company, given the high fixed cost and relatively inefficient personnel utilization. The time crunch that creates the need for processing centers significantly adds to the cost too. Thus, banks branch maximize neither customer satisfaction nor company profitability. Additionally, bank branches in remote areas are connected via satellite links and herein, data losses, and delay are the main concerns.

Users face similar challenges when using services such as telecom services, postal services, and the like. Thus, there is a need to address these continuing challenges associated with various services.

### SUMMARY

The present disclosure discloses a portable business operations system including a multi-function device, a network interface and a user interface. As disclosed, the multi-function device is configured to receive and identify a request type from a user. Based on the request, the multi-function device performs one of: printing, scanning or copying a document. The multi-function device further parses the content of one or more filled in application forms and verifies the completeness or accuracy of the forms. The network interface provides connectivity and communication between the portable system and one or more remotely located systems. Moreover, the user interface is coupled to the multi-function device and the network interface to send a request to the one or more remotely located systems. The user interface also allows completing one or more forms electronically, for a pre-defined service. Additionally, the user interface sends or receives electronic documents to and from the one or more remotely located systems.

Some embodiments of the disclosure describe a portable banking system. The portable banking system includes a multi-function device configured for: receiving and identifying a request type received from a user. Responsive to the request, the multi-function device performs performing at least one of: printing, scanning, or copying a document provided by the user. The multi-function device also parses the content of one or more filled in application forms or verifies the completeness or accuracy of the forms. The portable banking system further includes a network interface for providing connectivity and communication between the portable system and one or more remotely located systems, including headquarters systems, support systems, or peer systems. Moreover, the portable banking system includes a user interface, coupled to the multi-function device and the network interface, configured to perform one or more functions including: enabling a user to access one or more bank related services, including at least one of: opening a new account, changing personal information, applying for a loan, or issuing a checkbook. The user interface further performs functions of sending a request to the one or more remotely located systems. The user interface also allows completing one or more forms electronically, for a predefined service. Additionally, the user interface allows sending or receiving electronic documents to and from the one or more remotely located systems.

Additional embodiments of the disclosure describe a method for providing business center related services. The method includes providing a multi-function device for receiving and identifying a request type received from a user. Responsive to the request, the multi-function device performs at least one of printing, scanning, or copying a document provided by the user. Moreover, the multi-function device parses the content of one or more filled in application forms or verifies the completeness or accuracy of the one or more filled in forms. The method further includes interfacing with a network to provide connectivity and communication between the portable system and one or more remotely located systems, including headquarters systems, support systems, or peer systems. Moreover, the method includes interfacing with a user to perform one or more functions, including: enabling a user to access one or more bank related services, including at least one of: opening a new account, changing personal information, applying for a loan, or issuing a checkbook. The step of interfacing with the user also includes sending a request to the one or more remotely located systems. The step of interfacing additionally includes completing one or more forms electronically, for a predefined service, or sending or receiving electronic documents to and from the one or more remotely located systems.

Other embodiments of the disclosure describe a computer program product embodied on a computer readable medium having instructions to perform business center operations. The computer program product performs the steps as outlined above.

### BRIEF DESCRIPTION OF THE DRAWINGS

FIG. 1 illustrates an exemplary overall system according to an embodiment of the disclosure.

FIG. 2 shows various components for functioning of the overall system.

FIG. 3 is an exemplary method flowchart for providing business center related services to a user.

FIG. 4 is a screenshot displaying various options to a user.

FIG. 5 represents another exemplary snapshot illustrating one or more options, according to an embodiment of the present disclosure.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Definitions

In various embodiments of the present disclosure, definitions of one or more terms that will be used in the document are described below. The “portable system” is a device performing various types of operations that are generally performed in a business center such as bank branch, telecom center, postal office, or the like. The portable system is capable of receiving an input and displays an output.

As used herein, a Multi-Function Device (MFD) includes a single device that offers a number of traditionally separate functionalities, such as printing, copying, scanning, and faxing. It is envisioned that the MFD can participate in a network with a number of other devices and entities. There, a “headquarters” device refers to a device at a higher organizational level than the MFD; “peer” devices are on the same general organizational level as the MFD; and “support systems” or “back-office” systems perform support and services operations, such as data entry, verifying documents, or processing transactions, and the like.

### Overview

The primary aim of the present disclosure is to create a new branch operation, such as a bank branch, telecom center, postal office, or the like, at very low operating cost. The branch or the center is created in the form of a portable system that perform all typical operations such as filling application forms, verifying forms, performing business center operations including uploading or downloading daily reports, requesting stationary and so on. The portable system performs most of the operations that are today in bank branches, for example, thus, a customer need not travel distances and stand in queues, and on the other hand, banks can open more branches to perform the required operations through this portable system. The portable system reduces a significant portion of cost with respect to processing centers, and reduces processing time too. Further, the portable system optimizes all document-driven workflows, thereby reducing hard copy usage. Moreover, the portable system communicates over a network and provides smooth workflow even at slow speeds. The portable system can be easily moved from one area to another area. It can be fixed in an area with very low operating cost as well as minimum officials are required to manage it, thus, the overall cost is reduced.

Generally, the portable system includes a user interface, a multi-function device, and a network interface. The portable system is capable to manage information in the form of one or more electronic documents. The user interface, multi-function device and the network interface are connected to each other, allowing the portable system to perform the desired task. The user interface allows the user to fill one or more applications forms or further allows the user to access any service. Further, the multi-function device performs printing the forms, scanning documents and the like. Moreover, network interface connects the portable system to various back-end offices via network.

For some embodiments of the disclosure, the portable system may be embodied in the form of a portable banking system. The portable banking system performs all types of operations that are usually performed in any bank branch and further provides various bank related services to the user. Few such examples of services may include, but are not limited to, creating a new account, changing personal information, applying for loans, printing reports, managing profile, viewing customer accounts, viewing branch reports, uploading documents, and downloading documents. Further, the portable banking system automates the process associated with any bank related activity/service.

Other embodiments of the present disclosure direct toward a portable system such as a portable telecom system. The portable telecom system assist in providing various telecom services to users. Examples of such services may include, buying a prepaid connection, buying a postpaid connection, paying phone bills, viewing pending bills, changing personal information, recharging phones, managing profiles, moving/porting mobile number from one operator to the other, and so forth,

Additional embodiments of the present disclosure relate to a portable post-office system. The portable post-office system provides various postal services to users. The postal services may include, opening a postal saving account, RD account, postal money order, or buying stamps.

### Exemplary Overall System

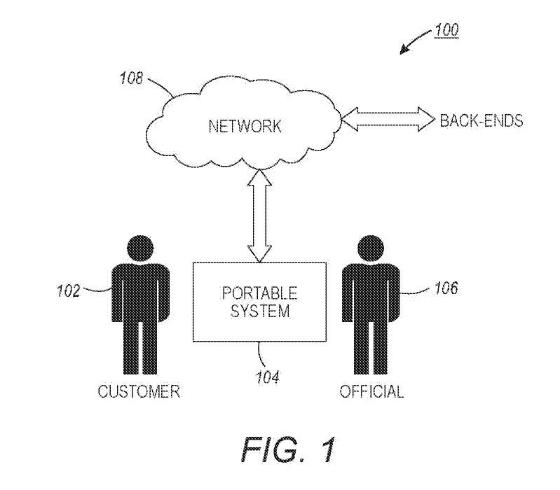

FIG. 1 illustrates an exemplary overall system 100 in which various embodiments of the present disclosure can be practiced. In particular, FIG. 1 includes a customer 102, a portable system 104, an official 106, and a network 108. Customer 102 and official 106 interact with portable system 104 for various purposes. Further, portable system 104 connects to network 108 for sending and/or receiving data. Portable system 104 and network 108 communicate using conventional network protocols. The network 108 connects the portable system 104 to various back-ends (will be discussed in detail below) for further processing.

In one embodiment, the overall system 100 may include two or more portable systems those can be placed in any area, based on the needs of customers. According to this embodiment, the two or more portable systems may be connected with each other via network 108.

For the sake of simplicity, the present disclosure will be described using banking as one of the application areas. Accordingly, a portable system may be referred to as a portable banking system. However, for a person ordinary skilled in the art, it is understood that the disclosure may be implemented for various other domains including telecom, post-offices, and so forth.

Customer 102 uses portable system 104, for example, portable banking system for various purposes, but not limited to, opening a new bank account, applying for a loan, changing personal information, and similar services. Various account types may include, checking accounts, current accounts, savings accounts, and so forth. Portable system 104 will now be referred to as a portable banking system.

Customer 102 is required to provide one or more credentials, such as username and password, to access the portable banking system. After the successful login, various options such as creating a new account, and paying bills, are displayed to customer 102. Based on the option chosen, customer 102 may require to fill out an application form displayed on the portable banking system and the filled application form is then sent over network 108 for further processing. For example, if customer 102 chooses an option “apply for loan”, she needs to fill out the corresponding application form. In another example, if customer 102 opts for “view summary statement,” she is displayed with the account summary statement. In one embodiment, the official 106 may fill an application form on the behalf of the customer 102.

As described above, the portable banking system acts as a bank branch in itself to perform all types of bank operations. Typically, the portable banking system can be placed in any area including rural area or urban area.

Further, the portable banking system is connected to various back-end offices via the network 108. Different back-end offices may include, a remote bank branch, processing centers for requesting stationary, a third party validation systems, or the like. Moreover, the portable banking system is capable of sending or receiving information electronically via network 108. This reduces the need to courier documents, for example, an application form, an identity proof, an address proof, and a photograph, to the banking organization. Thus, the usage of hard copy is reduced. In addition to this, the portable banking system is configured to compute the information.

As shown in FIG. 1, official 106 includes a bank employee, for example, a branch manager. Official 106 uses the portable banking system to perform one or more functions, but not limited to, managing customer accounts, managing branch reports, managing req directs, opening new accounts. In one embodiment of the disclosure, official 106 may upload and download one or more documents. The documents may relate to customer 102 or may correspond to branch reports and the like. Alternatively, portable system 104 may be operated without an official 106.

In one embodiment, official 106 may assist customer 102 in various bank related activities including filling an application form, verifying the information of customer 102 and so forth. In an embodiment of, official 106 may perform one or more functions, for example, filling tax saving form, filling DA1 nomination form, signature change form, and the like, on the behalf of customer 102.

Network 108 is typically used to connect the portable banking system to headquarters systems, support systems or peer systems. The support systems or the peer systems forming a part of back-offices, including a stationery office, a processing center for verifying the one or more filled in forms and documents, an office for data entry, an office for courier or shipping of documents, third party validation systems or a center for any other manual work. According to an embodiment of the present disclosure, network 108 may be wired or wireless. Network 108 includes all types of conventional wired or wireless network. Various examples of such networks include, but not limited to, Local Area Network (LAN), Wide Area Network (WAN), a Metropolitan Area Network (MAN), Wireless LAN, and so forth. Additionally, network 108 can be a local, regional, or global communication network such as an enterprise telecommunication network, the Internet, a global mobile communication network, or any combination of similar systems. For example, network 108 may be an interconnection between an enterprise network, the internet, and a cellular network. When network 108 is a combination of an enterprise network (or the Internet), and a cellular network, suitable means are employed to seamlessly communicate between the two networks. For instance, a mobile switching gateway may communicate with a computer network gateway to pass data between the two networks. Similarly, if network 108 includes two or more networks employing differing protocols, suitable interfaces may be introduced to allow communication between these disparate networks.

In case, network 108 connecting the portable banking system is wireless, the portable banking system includes a cellular interface integrated on it providing cellular capability. The cellular interface further facilitates communication with network 108.

### Exemplary System Components

Typically, remote areas lack infrastructure and sometimes it is difficult to set up a permanent facility there like a branch or a center. Establishing a branch in such areas requires a high operating cost and return revenue stream is low. To serve the needs of such areas, the present disclosure proposes a portable system that performs operations that are performed on daily basis. The portable system can be moved from one rural area to other areas based on the requirements of customers of that particular area. Furthermore, the portable system requires one or more officials to run the branch, and thus, minimum staffing is required. Moreover, the portable system requires minimum power consumption to run. Thus, the overall cost of setting up a portable system in such areas is reduced largely. Therefore, the portable system is efficient in terms of capital cost, and operating cost. In addition to the above, the portable system enables users to perform one or more activities electronically and thus, optimizes paper related work. More than that, the portable system has automated workflows and is integrated with different back-end offices including remote branches, third party validation systems and the like.

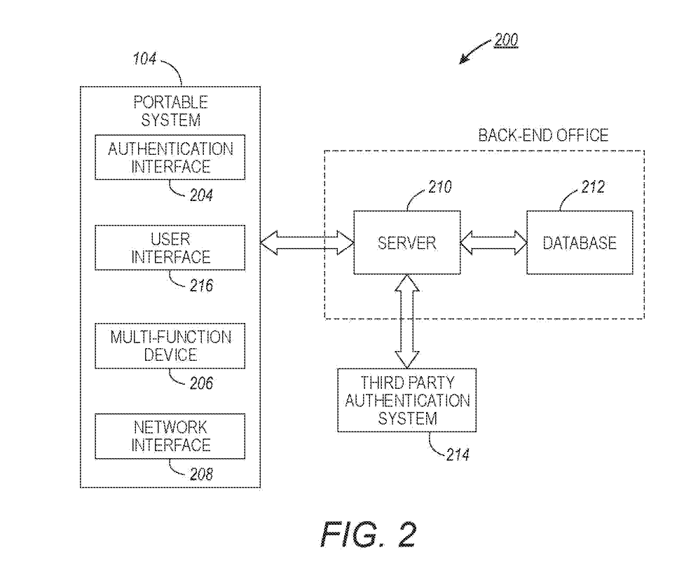

FIG. 2 shows various components and system elements for implementing embodiments of the present disclosure. To analyze the present disclosure, FIG. 2 illustrates the portable system 104, a server 210, a database 212, and a third party authentication system 214. Further, portable system 104 includes an authentication interface 204, a user interface 216, a multi-function device 206, and a network interface 208. As depicted in FIG. 2, the portable system 104 communicates with server 210 using conventional network protocols and server 210 further communicates with database 212 for storage. Moreover, server 210 communicates with third party authentication system 214. Additionally, server 210 and database 212 collectively, forms a part of a back-office, a remote branch, for example. Each of these system components will be described in detail in the following sections.

For one embodiment of the present disclosure, portable system 104 is integrated with bank services. According to this embodiment, portable system 104 is embodied in the form of a portable banking system facilitating all types of bank services to users. In another exemplary embodiment, portable system 104 may be integrated with telecom services. For such scenarios, portable system 104 in the form of a portable telecom system provides various telecom services to users. Additionally, portable system 104 may be integrated with postal services. For such embodiments, portable system 104 is referred to a portal post-office system providing postal services to users. In additional embodiments, portable system 104 may be integrated with various types of services according to the requirements.

For the sake of explaining various embodiments of FIG. 2, an example of portable banking system is used. It is clear, however, to a person skilled in the art that the disclosure is not limited to the embodiment described herein.

The portable banking system performs all functions that are operated by a bank and thereby, allowing users to perform any bank related activity. As mentioned above, the portable banking system includes authentication interface 204, user interface 216, multi-function device 206, and network interface 208.

In an embodiment, the portable banking system may further include an input interface, an output interface, an Automated Teller Machine (ATM), a processing module, an extraction module, a categorization module, a cellular interface, a power source, a physical case, and an internal storage device. According to an aspect of the disclosure, various components of the portable banking system such as ATM, cellular interface, an internal storage device, a physical case can be separated and can be re-attached to the portable banking system later. The components as mentioned above may be in the form of hardware or software modules. In an embodiment of the present disclosure, any other components including software and/or hardware components that are required for operating the portable banking system, can be easily integrated with it.

Additionally, the components/modules of the portable banking system are connected internally via a communication bus that is known in the art and need not to be described herein. The aforesaid components perform their respective functions and further interact with each other, thereby, enabling the portable banking system to function appropriately.

In one aspect of the disclosure, the portable banking system may have multiple user interfaces so that multiple users can access the portable banking system simultaneously. As an example, the exemplary embodiment may include multiple terminals with an application running the terminals and interacting to the portable system. Each terminal is used by a customer and thus, serve multiple customers simultaneously.

The authentication interface 204 as above performs authentication for a user. In particular, the authentication interface 204 authenticates the user based on the credentials input by the user, for example, user name, and password. In other embodiments, the authentication interface 204 authenticates the user based on the fingerprint or thumbprint as the input.

Multi-function device 206 herein represents a single unit performing one or more functionalities. As mentioned herein, the multi-function device 206 is generally utilized for printing, scanning, copying, faxing data and/or other known imaging functions. The data may be in the form of one or more documents. Additionally, the multi-device 206 may perform image processing functions when required. The multi-function device 206 may be further utilized for enhancing the quality of scanned information by skewing the information appropriately, varying the contrast, removing the noise and so forth. It will be understood that the multi-function device 206 may perform one, few, or all of the mentioned operations without departing from the scope of the disclosure.

Moreover, the multi-function device 206 is configured intelligently to identify the request type received from the user. Based on the request type, the multi-function device 206 connects the portable system to the desired back-office. For example, if the user requests for uploading or downloading documents, then the multi-function device 206 may connect the portable system to the remote bank branch. If the user puts a request for stationary, then the portable system is connected to the stationary office. In an embodiment, the multi-function device 206 may include an intelligent processing module to perform the above-mentioned processes.

Additionally, the multi-function device 206 may include a database for storing information.

As described above, the multi-function device 206 may be replaced with one or more units having the functionalities of printing, scanning, copying, and faxing. Alternatively, the multi-function device 206 may be replaced with a printer, a scanner, and a copier. For various other embodiments, the multi-function device 206 may be a standalone printer or facsimile machine. The multi-function device 206 performs various functions as known in the art. In one exemplary embodiment, the multi-function device 206 can perform financial transactions based upon one or more checks, depositing money, debiting money, for example. The multi-function device 206 can also scan the content of the checks. In addition, the multi-function device 206 can print the checks based on the request by the user 102.

User Interface (UI) 216 enables the user to perform one or more branch related activities. In particular, the user interface 216 is used for receiving an input and displaying an output in the desired format. In one embodiment, the UI 216 displays one or more instructions on the display, or relay them over the audio system. Some instructions may require user inputs as well. In such instances, UI 216 may impart interactive capabilities to the display device, allowing users to provide information through a keypad, a touchpad, or simple operation buttons on the portable banking system. Further, the UI 216 of the portable banking system is interactive and elaborative enough so that the user can easily perform the desired activity. Accordingly, the user can move from one screen to other with ease. In addition, the UI 216 is searchable and further allows the user to locate the required information.

In an embodiment, the UI 216 may include an intuitive UI. Alternatively, the UI 216 may be configured to recognize gesture. For other embodiments, the UI 216 may include multiple modes of communication, for example, it may be a simple display, an interactive touch screen display, an audio system, a combination of a display and audio system. The UI 216 may further receive the processed information from the processing module for display.

Further, the network interface 208 connects the portable banking system to the network and the network further connects the portable banking system to different back-end offices, a remote bank branch, for example. The network interface 208 further facilitates smooth communication between the portable banking system and the remote bank branch. In an embodiment, the network interface 208 may be integrated with the multi-function device 206.

The input interface as described above receives an input provided by the user. In one aspect of the present disclosure, the input may be provided using input devices such as a keyboard, mouse, display, user interface, touch pad, and the like. Moreover, the output interface provides the output to the user in various forms including document, and display. Various examples of output devices may include, but not limited to, printer, scanner, display, and so forth. In another example, the output device may include the multi-function device 206.

The ATM as included in the portable banking system has a conventional structure/functionalities and need not to be described herein in detail. The ATM typically allows the user to conduct any monetary transaction. Further, the processing module processes/computes the information. Furthermore, the compression/decompression module compresses or decompresses the information using one or more pre-defined algorithms as known in the art and thus, need not be described in detail.

The extraction module extracts one or more fields such as first name, last name, age, phone number, and address, from the information. Moreover, the categorization module categorizes the information based on one or more parameters, but not limited to, account type, customer type, and so forth.

The cellular interface as mentioned above provides cellular capability to the portable banking system. Usually, the cellular interface connects the portable banking system to the network via wireless communication channel even when the portable banking system is being moved from one place to other.

In one embodiment, the cellular interface may allow the portable banking system to receive information from other portable banking system and send information to the other portable banking system. To this end, the cellular interface includes a cellular port and a cellular card. Further, the cellular card may employ hardware, software, and firmware, imparting cellular functionality to the portable banking system. Additionally, cellular card can employ a cellular modem via which the portable banking system can be accessed. Such cellular components are known to those in the art and thus, need not be described in detail here. It is to be appreciated and understood that cellular components need not reside inside the portable banking system. Some of the components that impart cellular functionality can be configured externally to the portable banking system. The cellular interface may also include a cellular antenna (not shown) to detect cellular signals and transmit information when required.

The cellular interface may include any known cellular technology, such as global system of mobile communication (GSM), code division multiple access (CDMA), wideband CDMA (WCDMA), Time Division Synchronous CDMA (TD-SCDMA), and so on. It will be understood that any known or future developed telecommunication technology may be utilized to provide cellular connectivity to the present day. In case of GSM technology, the cellular card may be a Subscriber Identity module (SIM card). It will be understood that because the portable banking system is connected to a cellular interface it may be moved anywhere in the world.

As mentioned above, the portable banking system includes a power source such as a battery for providing power to the banking system. The power source may include a car battery or a fueled power generator.

Additionally, the physical case as mentioned above represents a box in which the portable banking system can be placed. The internal storage device as above stores information locally in the portable banking system. Thus, maintaining the information locally on the portable banking system acts as a backup in case of data losses at server end. The information may relate to a customer, a bank employee, bank related activity, bank services, users' profiles, user preferences, user history, and so forth.

According to an embodiment of the present disclosure, the portable banking system may include slots for platen. A platen is a flat plate pressed against a medium such as paper to cause an impression in printing or any imaging functions.

Moreover, the portable banking system may include a back-office interface. The back-office interface connects the portable banking system to various bank-end offices such as a remote bank branch, an office for requesting the stationary, or the like. According to this embodiment, the portable banking system can access servers, database, and systems present in the back-end offices. The back-offices may perform any manual work if needed, such as data entry, courier, shipping and so forth.

For one embodiment of the disclosure, any type of user including a customer or an official such as a bank employee may use the portable banking system. Further, the customers may be in the form of individuals or business. The officials may check the logs twice a day, for example, beginning of day and end of day via the portable banking system. Customers may use the portable banking system for multiple purposes such as savings, loans, investments, taxes, bill payments, cheques, and other similar services.

As illustrated in FIG. 2, server 210 such as bank server receives information from the portable banking system and performs various functions including compression, de-compression, extraction, categorization, and so forth. These functions are discussed above in detail. Server 210 further sends the required information to the portable banking system. Similarly, server 210 receives information from the portable banking system. Along with this, server 210 interacts with third party authentication system 214 for validations. Database 212 such as bank database stores information relating to users, services, and the like. In one embodiment, functionalities of database 212 may be integrated with server 210 and thus, a single unit can be formulated.

Additionally, third party authentication system 214 verifies whether the information provided by the user is true. The third party authentication system 214 further checks whether the information, for example, identity proof, address proof, as provided by the customer are correct. Various examples of identity proof may include, but not limited to, PAN card. Examples of various address proof may include, but not limited to, Voter ID, Ration card, driving license, passport, and so forth. In an example, the third party authentication system 214 as mentioned herein may check whether the PAN number matches with the name of the customer and so on. Post verifying the information, the third party authentication system 214 communicates the outcome to the server 210. Subsequently, a bank employee or the server 210 takes the necessary actions.

For one embodiment, the server 210 may be connected to the third party authentication system 214 via an Application Program Interface (API).

### Exemplary Use of Portable System

For the sake of understanding the disclosure, an exemplary method is described below. In simple words, to understand the functioning of the present disclosure, an exemplary method is outlined below. However, the exemplary method as recited should not limit the scope of the present disclosure. The method is described for a scenario when a customer accesses portable system 104, for example, portable banking system.

### At Portable System

Initially, customer 102 logs into the portable banking system. To login, the customer 102 needs to provide their credentials, for example, user name, and password. After this, the credential details are compressed and then transmitted to server 210, such as the bank server. Then, a check is performed to verify whether the credentials as input by the customer 102 are correct. In case the credentials input by the customer 102 are not correct, she is not allowed to proceed further. Else, one or more options are displayed to the customer 102 via the UI 216. Various options may include, but not limited to, creating a new account, applying for loans and so forth.

In an example, it can be considered that the customer 102 wishes to open an account with a bank, accordingly, she chooses an option to create a new account. Various types of accounts are offered by a banking organization, such as current account, saving account, foreign currency account, and term deposit account. The customer 102 then choose an account type she wishes to have, based on her requirements. The customer 102 may have different types of bank accounts with a banking organization. In an embodiment, the bank related services may be prioritized by the bank organization based on their requirements. For example, opening a bank account may be prioritized in comparison to fund transfers, and bill payments.

After choosing the appropriate option, an application form is displayed to the customer 102 including one or fields such as first name, last name, age, date of birth, permanent address, current residential address, and the like. Accordingly, the customer 102 inputs the required information through the portable banking system. Also, the official 106 present with the portable banking system may help the customer 102 to understand the application form and may further assist the customer 102 while filling various fields in the application form. The customer 102 may be required to fill out various forms such as signature change form, DA1 nomination form, tax forms, tax avoidance form, and internet banking form. For one embodiment, the official 106 may fill these application forms on the behalf of the customer 102 later.

On successful completion of the application form, a registration number is assigned to the customer 102. Then, the customer 102 is required to print the filled application form. This can be done using a print command. Thereafter, the customer 102 scans the filled application form. For this, the customer is required to place the document on the platen of the portable banking system and accordingly, the document is scanned. During scanning, the portable banking system extracts one or more fields such as name, account type, and location, from the forms and save it in the local database of the portable banking system. Before storing the extracted data fields, they are compressed. Then, the information present in the scanned document may be realigned and enhanced further for clarity purposes. Thereafter, the customer 102 needs to provide one or more supporting documents, for example, identity proof, address proof, and so forth, for scanning At the time of scanning, image of the document is also captured.

While scanning the supporting documents, it is verified whether the information filled by the customer 102 in the application form matches with the information provided in the supporting documents. In case of successful verification, the scanned application form and the associated documents are sent to the network 108. For example, it is checked whether the name provided by the customer 102 in the application form matches with the name mentioned on the identity proof. Then, the information in the form of electronic documents is transmitted from the portable banking system to the network 108. In particular, filled in information such as name, age, address, phone number, and the like is sent to the network 108 and images or graphics are reproduced at server end. The information is compressed before sending it.

If the verification check fails, the customer 102 is prompted again to provide the correct information.

Additionally, the data extracted while scanning the documents can be further used for categorizing the information. The categorization can be performed based on various parameters such as account type, customer type and so forth.

### At Remote Branch

At server 210, the scanned electronic documents received from the portable banking system are uncompressed and then stored in the database 212, for example, bank database. In the similar manner, the information from the documents are extracted and are further saved in the database 212. Also, a bank employee in the remote branch may perform an additional check to assure the information provided in the filled application form matches with the supporting documents. Along with this, the bank employee may crosscheck the information/content extraction entries against the electronic documents. Then, the server 210 sends the required information such as PAN card to the third party authentication system 214 for validation. In case of successful validation, the bank server proceeds with next steps.

Subsequently, a confirmation is sent to the customer 102 for the account creation. Typically, a unique account number or the customer identification number is provided by the banking organization through the portable banking system. Also, instant bank opening pack is sent to the customer 102. Thus, the overall processing time to create the new account is reduced largely. Similarly, the customer 102 may use the portable banking system for other services as mentioned above.

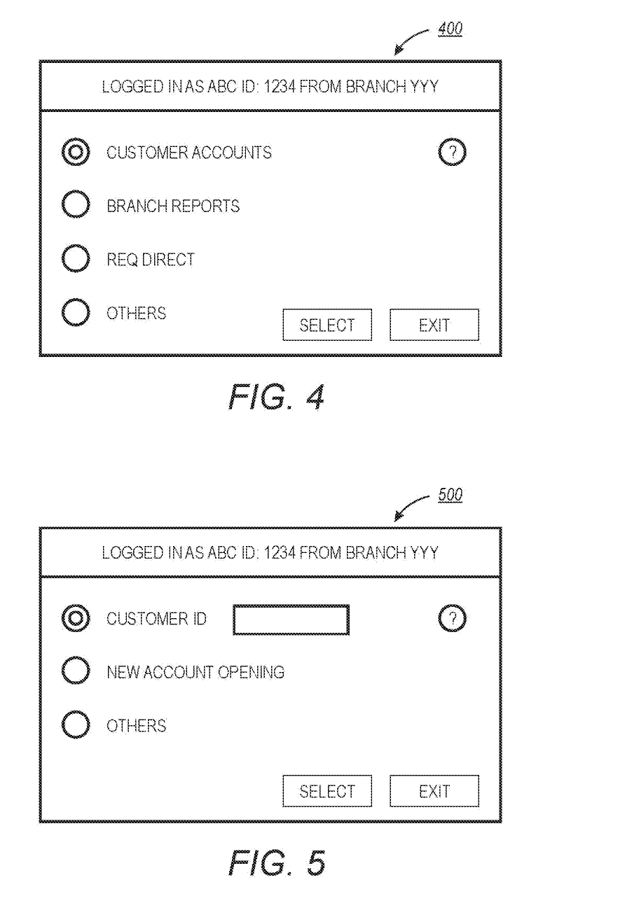

In one embodiment, the official 106 may also use the portable banking system for various purposes. When the official 106 logs into the portable banking system, then options, for example, branch reports, and customer accounts, are displayed as shown in FIG. 4. In case the official 106 chooses an option, customer account, then a user interface as shown in FIG. 5 is displayed.

For scenarios, where a bank employee wishes to create a new account with the banking organization, she follows the similar process as outlined above. However, the required modifications/variations to the above can be made.

### Exemplary Method Flowchart

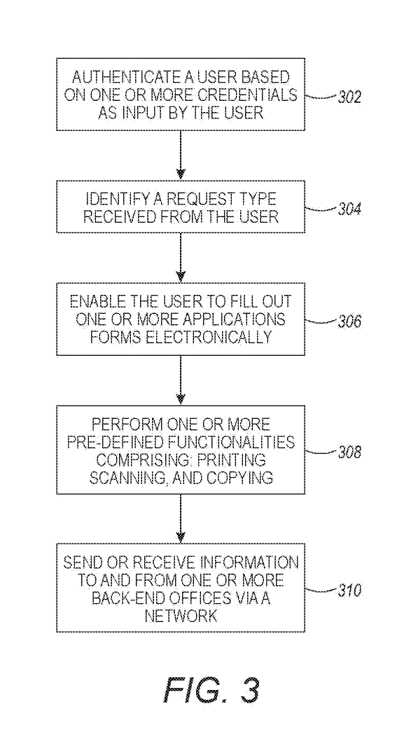

FIG. 3 is an exemplary method flowchart for providing business center related services to users, according to an embodiment of the present disclosure.

In the present embodiment, the user may include a customer and/or a bank employee.

To start, a user accesses a portable system, for example, portable banking system to use one or more services. Examples of various services are mentioned above in detail and thus, can be referred to. In particular, the user inputs his/her credentials to access the portable system. After this, the user is authenticated based on the credentials as input. Then, various options are displayed to the user via a user interface. Thereafter, the user chooses an option based on his/her preferences. Then, a multi-function device is provided to receive and identify a request type based on the option chosen by the user, at step 302. Accordingly, the user may need to fill out one or more application forms electronically. Then, at step 304, one or more pre-defined functionalities including printing, scanning, and copying are performed, responsive to the request type. Additionally, the steps of parsing the content of one or more filled in application forms or verifying the completeness or accuracy of the forms are performed respectively, at 306, 308.

Furthermore, the method executes step 310 of interfacing with a network to provide connectivity and communication between the portable system and one or more remotely located systems including headquarter systems, support systems, or peer systems. Accordingly, a step of sending or receiving information to and from the remotely located systems is performed. The information is sent or received via the network. Here, the support systems form a part of back-end offices including a stationery office, a processing center for verifying the one or more filled in forms and documents, an office for data entry, an office for courier or shipping of documents, third party validation systems or a center for any other manual work.

Additionally, the method allows interfacing with a user to perform one or more functions as follows. At step 312, the method enables a user to access one or more bank related services, including at least one of: opening a new account, changing personal information, applying for a loan, or issuing a checkbook. The interfacing step also includes the step 314 of sending a request to the one or more remotely located systems. It further includes completing one or more forms electronically, for a pre-defined service, at step 316. Additionally, the step of sending or receiving electronic documents to and from the one or more remotely located systems is performed at 318.

For a person skilled in the art, it must be clear that the steps as outlined in the method can be performed in any order to achieve the desired objective.

Various aspects of the disclosure as outlined above with respect to bank services/portable banking system are illustrative in nature. The disclosure can be implemented for various other types of services as discussed above in detail. Any modification/variation to the method and system above can be made without departing from the scope of the disclosure.

The present disclosure describes a portable system performs various operations. The portable system communicates over a network to facilitate various services to users. The portable system enables users to fill out information electronically, thereby reducing the usage of documents. Thus, the portable system optimizes the document-driven workflow. Further, one or more employees are required to operate the portable system, thus, reduces the staffing requirement. Also, the user can access the portable system anytime. Furthermore, the portable system can be easily moved from one location to another. The portable system also consumes less power. In addition, the portable system provides smooth workflow even at low connectivity speeds.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

1. A business operations system comprising:
a portable, self-contained multi-function device configured for:
receiving and identifying a request type received from a user;
responsive to the request, performing at least one of:
printing, scanning, or copying a document provided by the user;
parsing the content of one or more filled in application forms; or
verifying the completeness or accuracy of the one or more filled in forms;
a network interface providing connectivity and communication between the portable system and one or more remotely located systems, including headquarters systems, support systems, or peer systems; and
a user interface, coupled to the multi-function device and the network interface, configured to perform one or more functions including:
sending a request to the one or more remotely located systems;
completing one or more forms electronically, for a predefined service; or
sending or receiving electronic documents to and from the one or more remotely located systems.

2. The system of claim 1, wherein the multi-function device is configured to execute financial transactions based upon one or more checks.

3. The system of claim 1, wherein the support systems form a part of back-offices, including a stationery office, a processing center for verifying the one or more filled in forms and documents, an office for data entry, an office for courier or shipping of documents, third party validation systems or a center for any other manual work.

4. The table system of claim 1 further comprising an authentication interface for authenticating the user.

5. The system of claim 1 further comprising a processing module.

6. The system of claim 1 further comprising an extraction module configured to extract information.

7. The system of claim 1 further comprising a categorization module configured to categorize information based on one or more parameters.

8. The system of claim 1 further comprising a cellular interface providing cellular capability to the system.

9. The system of claim 1 further comprising an Automated Teller Machine (ATM).

10. The system of claim 1 further comprising a physical case to hold the system.

11. The system of claim 1 further comprising a power source to provide power to the system.

12. The system of claim 1 further comprising a storage device to store information.

13. A banking system comprising:
a portable, self-contained multi-function device configured for:
receiving and identifying a request type received from a user;
responsive to the request, performing at least one of:
printing, scanning, or copying a document provided by the user;
parsing the content of one or more filled in application forms; or
verifying the completeness or accuracy of the one or more filled in forms;
a network interface providing a connectivity and communication between the portable system and one or more remotely located systems, including headquarters systems, support systems, or peer systems; and
a user interface, coupled to the multi-function device and the network interface, configured to perform one or more functions including:
enabling a user to access one or more bank related services, including at least one of:
opening a new account, changing personal information, applying for a loan, or issuing a checkbook;
sending a request to the one or more remotely located systems;
completing one or more forms electronically, for a predefined service; or sending or receiving electronic documents to and from the one or more remotely located systems.

14. The banking system of claim 13 further comprising an authentication interface.

15. The banking system of claim 13 further comprising an internal storage device for storing information.

16. The banking system of claim 13 further comprising a cellular interface for providing cellular capability to the banking system.

17. A method for providing business center related services, the method comprising:
providing a portable, self-contained multi-function device configured for:
receiving and identifying a request type received from a user;
responsive to the request, performing at least one of:
printing, scanning, or copying a document provided by the user;
parsing the content of one or more filled in application forms; or
verifying the completeness or accuracy of the one or more filled in forms;
interfacing with a network to provide connectivity and communication between the portable system and one or more remotely located systems, including headquarters systems, support systems, or peer systems; and
interfacing with a user to perform one or more functions, including:
enabling a user to access one or more bank related services, including at least one of:
opening a new account, changing personal information, applying for a loan, or issuing a checkbook;
sending a request to the one or more remotely located systems;
completing one or more forms electronically, for a predefined service; or
sending or receiving electronic documents to and from the one or more remotely located systems.

18. The method of claim 17 further comprising storing the information.

19. A computer program product embodied on a computer readable medium having instructions to perform business center operations, the computer program product performing the steps of:
receiving and identifying a request type received from a user;
responsive to the request, performing on a portable, self-contained multi-function device at least one of:
printing, scanning, or copying a document provided by the user;
parsing the content of one or more filled in application forms; or
verifying the completeness or accuracy of the one or more filled in application forms;
interfacing with a network to provide connectivity and communication between a portable system and one or more remotely located systems, including headquarters systems, support systems, or peer systems; and
interfacing with a user to perform one or more functions, including:
enabling a user to access one or more bank related services, including at least one of:
opening a new account, changing personal information, applying for a loan, or issuing a checkbook;
sending a request to the one or more remotely located systems;
completing one or more forms electronically, for a predefined service; or
sending or receiving electronic documents to and from the one or more remotely located systems.
